(19) United States
(12) Patent Application Publication
(10) Pub. No.: US 2024/0037642 A1
(43) Pub. Date: Feb. 1, 2024

(54) RENTAL SYSTEM AND RENTAL METHOD THEREOF

(71) Applicant: Honda Motor Co., Ltd., Tokyo (JP)

(72) Inventors: Tiffany Hui-Fong TAM, Palos Verdes Estates, CA (US); Christopher John TARCHALA, Los Angeles, CA (US)

(73) Assignee: Honda Motor Co., Ltd., Tokyo (JP)

(21) Appl. No.: 17/877,730

(22) Filed: Jul. 29, 2022

(51) Int. Cl. G06Q 30/06

(52) U.S. Cl. CPC G06Q 30/0645

(57) ABSTRACT

A rental system includes rental projects and at least one user device. The rental objects are docked in at least one rental location. The least one user device includes a rental use interface, a rental owner interface, a display, and a controlling circuit. The rental user interface is configured for making service requests of the plurality of rental objects and identifying one of the rental objects for rent. The rental owner interface is configured for managing and authorizing the service requests of the rental objects. The controlling circuit is configured to receive the service requests and returning notifications associated with the rental objects. Moreover, the controlling circuit is configured to authorize the service requests for renting the plurality of rental objects. A rental method utilizing the rental system is also provided.

### BACKGROUND

In a shared economy, for best utilizing all the resources for reducing waste in daily life expense and environmental pollution, a peer-to-peer model for commercial or non-commercial sharing of underutilized goods or service capacity may be introduced. In conventional sharing models, sharing goods or objects may be merely shared or rented through direct inquiries between rental owners and users. Nevertheless, due to limitation in time and channels for sharing, availability information associated with the goods or objects for rent or share is difficult to be widely spread and learned by peers or other potential renters requesting rental services. Hence, the targeted audience for sharing or renting the underutilized goods or objects are limited to the immediate groups, such as family, close neighbors, friends, or colleagues, who may have direct contact or interaction with the rental owners of the underutilized goods without being able to further enlarge the targeted audience to reach those people who may live in the same community or even in the same town or same city. Therefore, a rental system for the rental owner of the sharing/rental objects to conveniently share or rent the sharing objects is in needs to enhance efficiency of sharing/renting processes.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to an embodiment of the disclosure, a rental system includes rental projects and at least one user device. The rental objects are docked in at least one rental location. The least one user device includes a rental use interface, a rental owner interface, a display, and a controlling circuit. The rental user interface is configured for making service requests of the plurality of rental objects and identifying one of the rental objects for rent. The rental owner interface is configured for managing and authorizing the service requests of the rental objects. The controlling circuit is configured to receive the service requests and returning notifications associated with the rental objects. Moreover, the controlling circuit is configured to authorize the service requests for renting the plurality of rental objects.

According to an embodiment of the disclosure, a rental method for rental objects docked in a rental location. The rental method includes listing rental objects docked in the rental location for rent by at least a rental owner through a rental owner interface of a rental system. A rental user interface of the rental system is accessed by a rental user to make service requests for the rental objects. Availabilities of the rental objects requested by the services made from the at least a rental user are determined. The returning information of the rental objects from the rental user interface is transmitted from the rental user interface to the rental owner interface for informing returns of the rental objects to rental owners.

### BRIEF DESCRIPTION OF THE DRAWINGS

FIG. 1 is a schematic diagram that illustrates an exemplary rental system for requesting service requests for the rental objects.

FIG. 2 is a block diagram that illustrates an exemplary network environment for management of service requests for the rental objects with an embodiment of the disclosure.

FIG. 3 is a schematic diagram that illustrates exemplary user devices for access to a rental user interface or a rental owner interface.

FIG. 4 is a flowchart that illustrates exemplary a rental method of a rental system in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in the disclosed rental system and method for management of tasks related to service requests for rental objects located in rental locations. The rental system may determine, based on the status and availabilities of the rental objects, whether the service request for the rental objects may be executable. The electronic device of the rental system may identify the rental objects available for fulfillment of the rental service requests. In the rental system, a display device (such as a smart phone, a wearable device, or a device having a display) may be controlled to display statuses of the service requests.

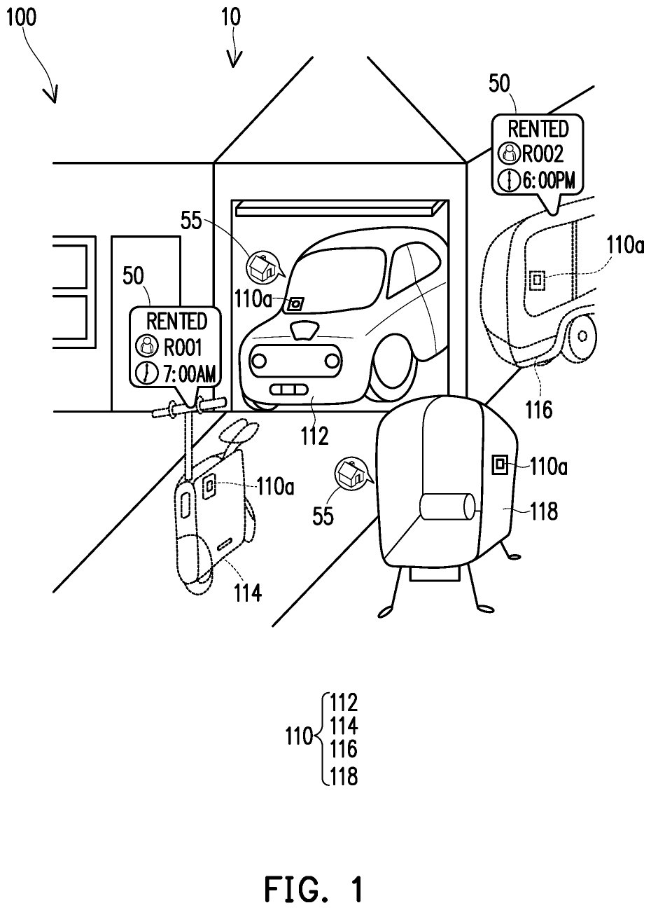

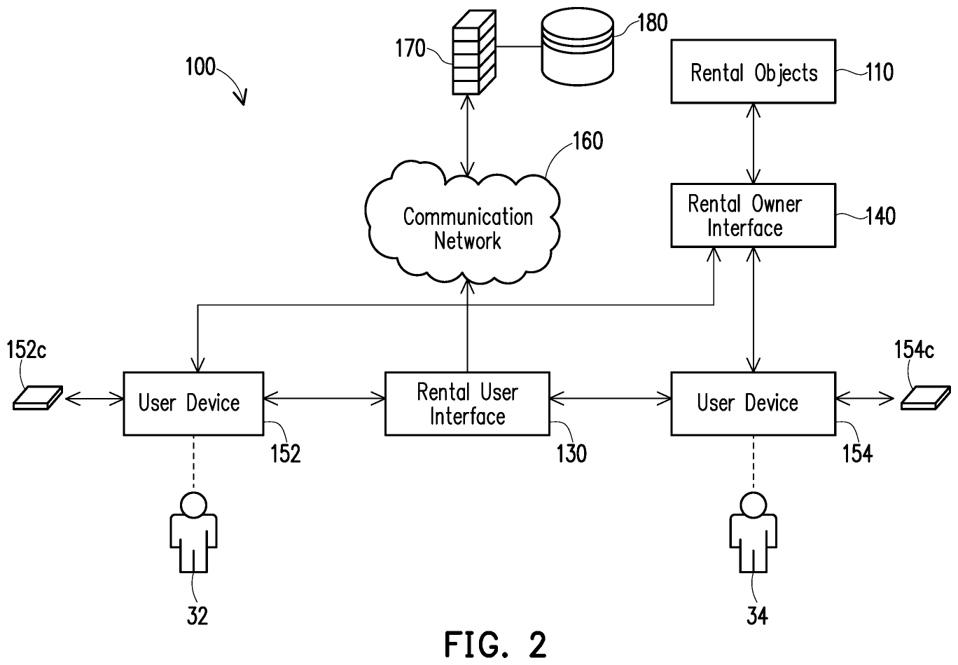

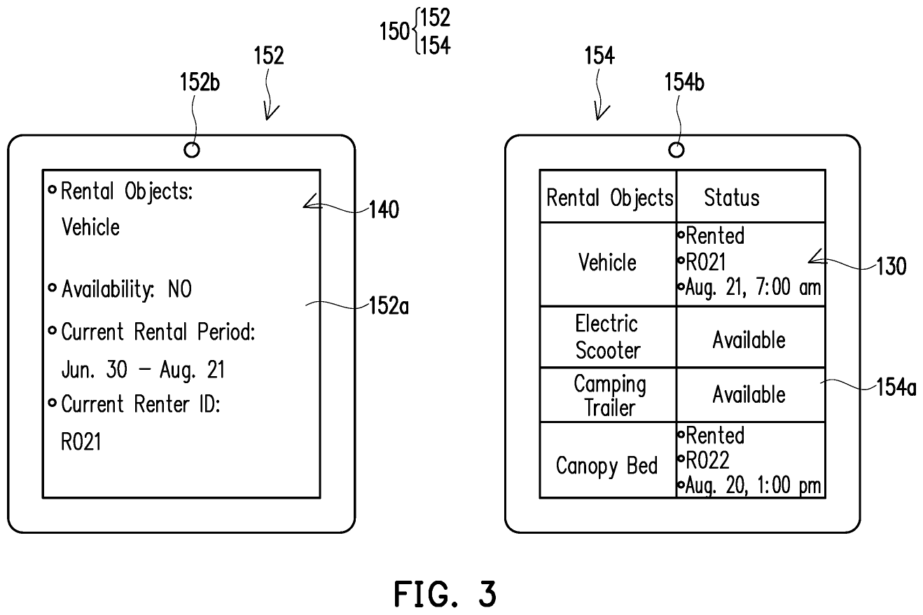

In the present disclosure, the rental system may be applied for a peer-to-peer mode of rental or sharing of the rental objects located in at least a rental location belonging to at least a rental owner. FIG. 1 is a schematic diagram that illustrates an exemplary rental system for requesting service requests for the rental objects. FIG. 2 is a block diagram that illustrates an exemplary network environment for management of service requests for the rental objects with an embodiment of the disclosure. FIG. 3 is a schematic diagram that illustrates exemplary user devices for access to a rental user interface or a rental owner interface. Referring to FIG. 1 to FIG. 3 in the present disclosure, a rental system 100 includes a plurality of rental objects 110. As shown in FIG. 1 and FIG. 3, the rental objects 110 may include, for example, a vehicle 112, an electric scooter 114, a camping trailer 116, or a canopy bed 118. In the present embodiment, the rental system 100 may further include at least a user device 150 controlled by users 32, 34 for access to the rental user interface 130 and the rental owner interface 140.

As shown in FIG. 1, the rental objects 110 may be docked in a rental location 10. In accordance with the current embodiment, the rental location 10 may be a storage, a garage, or a warehouse, which may be belonging to a rental owner of the rental objects 110.

In some embodiments, referring to FIG. 1 to FIG. 3, a rental status of each rental object 110 may be show on, for example, the displays of the user device 150. For example, a rental status 50 in FIG. 1 may be displayed on the user device 150 to inform the users 32, 34 of the most recent rental status of a rental object 110 including current renter's ID (e.g., R001, R002) and a scheduled returning time. Moreover, a status 55 may be displayed to inform the users 32, 34 that the specific rental object 110 is currently docked in the rental location 10 and thus available for next rental service.

Referring to FIG. 2., in accordance with the present embodiment, the at least one user device 150 may include a first user device 152 and a second user device 154 respectively utilized by at least two different users 32, 34. In the present embodiment, the first user device 152 and the second user device 154 may include, but not limited to, a mobile device such as a smartphone, a cellular phone, a mobile phone, or a consumer electronic (CE) device. In some embodiments, the first user device 152 and the second user device 154 may be respectively installed with an application software for a rental user interface 130 and a rental owner interface 140 being respectively implemented.

In some other embodiment, the first user device 152 and the second user device 154 may further include, but not limited to, a computing device, a desktop, a personal computer, a laptop, a computer workstation, a tablet computing device, a laptop a computer workstation, a tablet computing device, an Internet of Things (IoT) device, a wearable display, or a head mounted display.

As shown in FIG. 2, in the present embodiment, a first user 32 and a second user 34 may respectively have the first user device 152 and the second user device 154. The first user 32 and the second user 34 may access either to the rental user interface 130 or the renter owner interface 140 depending on the desired functions. Namely, the first user 32 and the second user 34 may respectively choose to either be a rental owner or a rental user for provide or requesting the rental services.

In the present embodiment, each of the rental objects 110 may have an identification label. In some of the embodiments, the identification labels 110a of the rental objects 110 might include quick response (QR) code labels for identification. In accordance with another embodiment, the identification labels 110a may include circuit chips for allowing Near-filed Communication (NFC) between the user device 150 and the rental objects 110. Hence, the operational information of the rental objects 110 may be transmitted to the user device 150, including the first user device 152 and the second user device 154, for attaining the statuses of the rental objects 110.

In accordance with the present embodiment, the rental user interface 130 may be configured for the rental user to make service requests for the rental objects 110 and to identify one of the rental objects 110 for rent or for share. In addition, the rental owner interface may be configured for managing and authorizing the service requests of the rental objects 110.

Referring to FIG. 2 and FIG. 3, the first user device 152 and the second user device 154 may be respectively disposed with displays 152a, 154a and controlling circuits 152c, 154c. The displays 152a, 154a may be respectively configured for displaying the rental user interface 130, the rental owner interface 140, and statuses of the rental objects 110. For example, as shown in FIG. 3, the display 152a of the first user device 152 displays the rental owner interface 140, which provides the associate information of the rental objects 110 for management by the rental owner. In contrast, the display 154a of the second user device 154 displays the rental user interface 130, which provides the associate information of the rental objects 110 with respect to their statuses.

Referring to FIG. 2 and FIG. 3, in the present embodiment, the user 32 may be identified as a rental owner, who accesses to the rental owner interface 140 through the first user device 152 for listing the rental objects 110 for rent or for share. Moreover, the user 34 may be identified as a rental user, who accesses to the rental user interface 130 through the second user device 154 for requesting the rental services of the rental objects 110.

Referring to FIG. 1 and FIG. 3, a live image of the rental location 10 (e.g., a garage) may be displayed through the display 152a of the first user device 152 or the display 154a of the second user device 154a. For example, as shown in FIG. 1, the electric scooter 114 and the camping trailer 116 had both been rented out and thus have the current rental status 50 being annotated close to the dashed line images thereof. The dashed line images respectively represent unavailability of the electric scooter 114 and the camping trailer 116. In the present embodiments, the information provided in the rental status 50 associated with the electric scooter 114 and the camping trailer 116 may include availability thereof, rental user IDs, and the scheduled returning time. In addition, as illustrated in FIG. 1, the vehicle 112 and the canopy bed 118 are both currently available, and thus no further rental information of the vehicle 112 and the canopy bed 118 are provided on the rental user interface 130. Instead, the vehicle 112 and the canopy bed 118 are simply annotated by the status 55 to indicate currently available at or near the garage 10.

Referring again to FIG. 2 and FIG. 3, the controlling circuits 152c, 154c of the first user device 152 and the second user device 154 may be configured to receive the service requests and returning notifications respectively associated with the rental objects 110. In addition, the controlling circuits 152c, 154c may be configured for wireless communication between the first user device 152 and the second user device 154.

In accordance with an embodiment, the controlling circuits 152c, 154c of the first user device 152 and the second user device 154 may include suitable logic, circuitry, and/or interfaces that may be configured to execute program instructions associated with different operations to be executed by the user devices 152, 154. The set of operations may include, but are not limited to, reception of a service request associated with the rental objects 110. The controlling circuits 152c, 154c may include any suitable special-purpose or general-purpose computer, computing entity, or processing device including various computer hardware or software modules and may be configured to execute instructions stored on any applicable computer-readable storage media. For example, the controlling circuits 152c, 154c may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. The controlling circuits 152c, 154c may include any number of processors configured to, individually or collectively, perform or direct performance of any number of operations of the user devices 152, 154, as described in the present disclosure. Examples of the controlling circuit 152c, 154c may include a Central Processing Unit (CPU), a Graphical Processing Unit (GPU), an ×86-based processor, an ×64-based processor, a Reduced Instruction Set Computing (RISC) processor, a Complex Instruction Set Computing (CISC) processor, and/or other hardware processors.

In accordance with some embodiments, the first and second user devices 152, 154 may include optical detectors 152b, 154b for scanning the QR code labels 110a respectively disposed on the rental objects 110 for activating the rental user interface 130 on the second user device 154 of the rental user 34 to transmit service requests to the rental owner interface 140 on the first user device 152 of the rental owner 32. In accordance with an embodiment, the optical detectors 152b, 154b may be cameras, and the displays 152a, 154b may correspondingly display the images of QR code labels 110a detect by the optical detectors 152b, 154b with their related information.

In some other embodiments, the user devices 150 may further include other electronic devices, such as personal computers or tablets, which may be configured to fulfill the tasks related to service requests for the rental objects. The electronic devices may execute operations through web applications, cloud applications, HTTP requests, repository operations, and file.

Referring again to FIG. 1, the vehicle 112 may be a non-autonomous vehicle, a semi-autonomous vehicle, or a fully autonomous vehicle, for example, as defined by National Highway Traffic Safety Administration (NHTSA). Examples of the vehicle 112 may include, but are not limited to, a personal transporter, an electric scooter, an electric hover board, an electric skateboard, a roller skate, a compact four-wheeler vehicle, a compact three-wheeler vehicle, a two-wheeler vehicle, a wheelchair with an actuator-based driving unit, a hybrid vehicle, or a vehicle with autonomous drive capability that uses one or more distinct renewable or non-renewable power sources. A vehicle that uses renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. Examples of the compact four-wheeler vehicle may include, but are not limited to, an electric car, an internal combustion engine (ICE)-based car, a fuel-cell based car, a solar powered-car, or a hybrid car. Similarly, examples of the two-wheeler vehicle may include, but are not limited to, an electric two-wheeler, an internal combustion engine (ICE)-based two-wheeler, or a hybrid two-wheeler. The description of other types of the vehicles has been omitted from the disclosure for the sake of brevity.

In some embodiments, in an embodiment not illustrated, an EV charger may be further disposed in the garage 10 for charging, for example, the vehicle 112 and the electric scooter 114 before providing the rental services thereof.

Referring again to FIG. 2, the rental system 100 may further include a communication network 160 to communicate the rental user interface 130 and the rental owner interface 140 on the different user devices 150 (e.g., the first user device 152 and the second user device 154). In further detail, the communication network 160 is utilized for wireless communication between the rental user interface 130 and the rental owner interface 140. The communication network 160 may be implemented by use of various conventional technologies to support wired or wireless communication between different user devices 152, 154 with the communication network 160. The communication network 160 may include, but is not limited to, an antenna, a RF transceiver, one or more amplifiers, a tuner, one or more oscillators, a digital signal processor, a CODEC chipset, a SIM card, or a local buffer circuitry. In some embodiments, the communication network 160 may be configured to communicate via wireless communication with networks, such as the Internet, an Intranet, or a wireless network, such as a cellular telephone network, a wireless LAN, and a MAN. The wireless communication may be configured to use one or more of a plurality of communication standards, protocols, and technologies, such as GSM, EDGE, W-CDMA, LTE, 5G NR, CDMA, TDMA, Bluetooth, Wi-Fi (such as IEEE 802.11a, IEEE 802.11b, IEEE 802.11g or IEEE 802.11n), VoIP, Li-Fi, Wi-MAX, a protocol for email, instant messaging, and a SMS.

As shown in FIG. 2, the rental system 100 may further include a server 170 coupled to the communication network 160. The server 170 may be an edge device or a distributed ledger (such as a Blockchain ledger). Moreover, exemplary implementations of the server 170 may also include but are not limited to, an application server a web server, a database server, a mainframe server, a could computer server, or combination thereof.

In some embodiments, the rental system 100 may also include a data base 180 coupled to the server 170. The data base 180 may include suitable logic, interfaces, and/or code that may be configured to store records associated service requests of the rental objects 110. Each record may include timestamps associated with one or more of reception of a service request, identification of the availability of the rental objects 110 to fulfill the service request, or completion of the tasks associated with the service request. The database 180 may be derived from data off a relational or non-relational database or a set of comma-separated values (csv) files stored on a conventional or a big-data storage. The database 180 may be stored or cached on a device, such as the user device 150. In some embodiments, the database 180 may be hosted on the user device 110 or the server 170. The operations of the database 180 may be executed by using hardware including a processor, a microprocessor (e.g., to perform or control performance of one or more operations), a field-programmable gate array (FPGA), or an application-specific integrated circuit (ASIC). In some other instances, the operations of the database 180 may be implemented by using software.

In the present embodiment, the users 32, 34 may respectively register to the rental user interface 130 and the rental owner interface 140 to be a rental user or a rental owner in the rental system 100. Each of the users 32, 34 may attain a user ID that is displayed on the rental user interface 130 and the rental owner interface 140 without directly displaying the personal information of the users 32, 34 in the rental system 100 for protecting user's privacy.

Referring to FIG. 1 to FIG. 3, the rental user interface 130 or the rental owner interface 140 may be displayed through the displays 152a, 154a of the user devices 152, 154. In the present embodiment, the statuses of the rental objects 110 may be displayed through the displays 152a, 154a. For example, as shown in FIG. 1 and FIG. 3, the displays 152a, 154a may display availabilities, renter IDs, and current rental periods of the rental objects 110. Through the rental information displayed on the displays 152a, 154a, the users 32, 34 may schedule and make service requests for the specific rental objects 110 based on their availabilities.

In accordance with another embodiment, one or more sensors wireless coupled with the user devices 152, 154 may be respectively disposed on the rental objects 110 to detect the defects or failures of the rental objects 110 for determining their availabilities.

Referring again to FIG. 1, as the rental objects 110 are the vehicle 112 or the electric scooter 114, the information associated with the status of the electric vehicle or the electric scooter including, but not limited to, State of Charge (SOC) of battery units of the rental objects 110 and normality thereof. In some embodiments, as the SOC of the battery units of the specific rental objects 110, such as an electric vehicle, is lower than, for example, 20% or the specific rental objects 110 are malfunctioned, unavailability of the specific rental objects 110 may be displayed on the rental user interface 130, or the specific rental objects 110 may be delisted from the rental user interface 130 for rental services.

In the present embodiment, the rental user interface 130 and the rental owner interface 140 may be implemented through the same application software installed in the user devices 152, 154. Hence, the identities of the users 32, 34 may be easily switched between the rental users and the rental owners for different rental functions. Therefore, the rental system 100 may be easily applied as a peer-to-peer mode rental, sharing, or exchange system for renting or sharing the rental objects 110 owned by different rental owners, which are docked in the garages the rental owners.

As shown in FIG. 3. in the present embodiments, the rental objects 110 may be listed through the rental owner interface 140 in the rental system 100. From the rental owner interface 140, the information of the rental users of the respective rental objects 110 in the current rental period could be attained. The information of the rental users may include, but not limited to, the contact information thereof provided in the duration of registration of the rental users to the rental system 100.

From the rental user interface 130, the rental user making the service requests of the rental objects 110 may attain the information associated with the individual rental objects 110. The information associated with the rental objects 110 displayed on the rental user interface 130 in the user device 152 may include availabilities or the current rental periods of the rental objects 150. In another embodiment, the information associated with the rental objects 110 might further include rental fee for renting the specific rental objects 110 requested by the rental user.

In an embodiment not illustrated, the rental user interface 130 of the user devices 150 may further include I/O device that may be configured to receive an input and provide an output based on the received input. The I/O device may include one or more input or output devices that may communicate with different components of the user interface. In at least an embodiment, the I/O device may include but not limited to, a touch screen, a keyboard, a mouse, a microphone, a joystick, a display device coupled to the user interface. The touch screen may be at least one of a resistive touch screen, a capacitive touch screen. The display device or the display screen may be realized through, for example, at least one of a Liquid Crystal Display (LCD) display, a Light Emitting Diode (LED) display, a plasma display, or an Organic Led (OLED) display technology, or other display devices.

In the present embodiment, the rental owner interface 140 may automatically determine availabilities of the rental objects 110 based on criteria pre-set by the rental owner or a machine learning process of the rental system 100. For instance, depending on the level of SOC of battery units, the rental owner of the rental objects 110 or the operator of the rental system 100 may predetermine whether the specific rental object (e.g., the electric vehicle) is in a capable condition for completing the tasks requested by the rental user. More specifically, the rental user requesting rental services of the electric vehicles 112 or electric scooters 114 may require a maximum traveling distance which cannot be fulfilled by the specific rental object 110 having lower level of SOC, the specific rental objects 110 will be determined and displayed as unavailable for the service requests on the rental user interface 130.

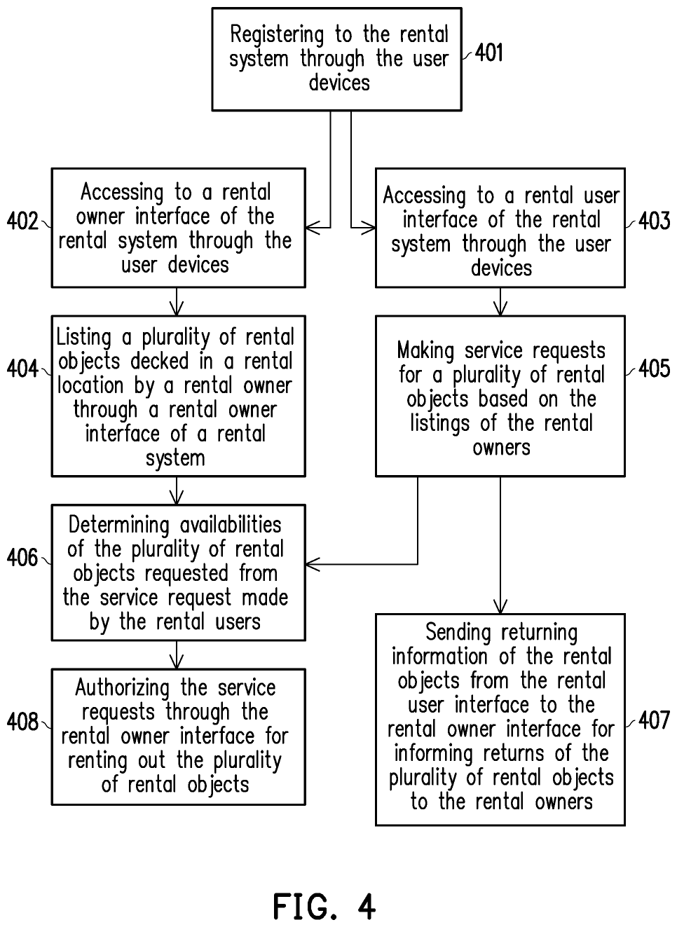

FIG. 4 is a flowchart that illustrates exemplary a rental method of a rental system in accordance with an embodiment of the disclosure. Referring to FIG. 4, the rental method may be applied for a plurality of rental objects 110 docked in the rental location, for example, the garage or storage of the rental owner. Referring to FIG. 1 to FIG. 4, in the step 402, the rental method may include registering to the rental system 100 through the user devices 152, 154. In addition, in the steps 402, 403, depending on the practical needs of users 32, 34, the users 32, 34 may choose either to access to the rental user interface 130 or the rental owner interface 140 by the user devices 152, 154 thereof.

In addition, in the step 404, after the user 32 or 34 accessing to a rental owner interface 140 of the rental system 100 through the user device 152 or 154, the user 32 or 34 may be identified as a rental owner. The rental owner may list a plurality of rental objects 110 docked in the rental location 10 through the rental owner interface 140 of the rental system 100.

As shown in FIG. 4, in the step 405, after the users 32 or 34 accessing to a rental user interface 130 of the rental system 100 through the user devices 152, 154, the user 32 or 34 may be identified as a rental user. The rental user may make service requests for the rental objects 110 based on the listings of rental objects 110 provided by the rental owner in the step 405.

Followingly, in the step 406, the rental owner may determine availabilities of the rental objects 110 requested from the service request made by the rental user. Sequentially, in the step 408, the service requests are authorized by the rental owner through the rental owner interface 140 for renting out the rental objects 110 requested by the rental user.

As shown in FIG. 4, in the step 407, after completing the rental periods of the rental user, the rental objects 110 may be returned by the rental user to the rental location 110, for example, the garage of the rental owner. The returning information of the rental objects 110 may be transmitted by the rental user interface 130 to the rental owner interface 140 for informing the returns of the rental objects 110 to the rental owners.

In some embodiments, the step of listing the rental objects 110 includes registering to the rental system by inputting necessary information, such as a phone number or an email address, by the rental owner of the rental objects to access to the rental owner interface. In the present embodiment, each of the rental objects 110 may be respectively labeled with, for example, a QR code label by the owner for identification of the user device. In some other embodiments not illustrated, the rental objects 110 may be embedded with the chip circuits for allowing NFC to transmit the data information between the rental objects 110 and the user devices 150.

The step of accessing to the rental system 100 by the rental user may further include registering to the rental system 100 with necessary credential information including, but not limited to, the personal contact information of the rental user, who requests the rental services of the rental objects 110.

In some embodiments, the owners of the rental objects may be also the users requesting rental services for the rental objects belonging to other owners. Hence, the registration information from the owner or user may be applied to both the rental user interface 130 and the rental owner interface 140. In the present embodiment, among several different owners of the rental objects, the rental objects may be exchanged or shared through the present rental system 130.

In accordance with another embodiment, the ownership of the rental objects 110 may a third-party owner or company, and the rental objects 110 may be docked in the rental user's place. Hence, the third-party owner may list their rental objects 110 for rent or for share by using the locations of garage or storage of the previous rental user as the rental location displayed on the rental user interface 130 and the rental owner interface 140 for the next rental user.

Referring to FIG. 2 and FIG. 4, in accordance with at least one of embodiments, the step of determining availability of the at least one rental object 110 may include detecting the operational status of the rental objects 110 by a controlling circuit 152c/154c of the user device 152/153 of the rental owner. For example, detecting the status of the rental objects 110 may further include detecting the normality of the rental objects 110, namely, detecting whether the rental objects may be normally operated or functioned. The detection of normality of the rental objects 110 may be implemented by chip circuits disposed in the rental objects 110 or by manual inspections. Referring to FIG. 1, as the rental objects 110 may be the electric vehicle 112 or the electric scooter 114, the detected status of the rental units may include SOC of battery units of the of the rental objects 110 and to control the rental owner interface 14—based on the detection of the battery states to display an option to transmit the service requests to the rental user interface 130.

In the present embodiment, the step of authorizing the service requests may include authorizing the service requests of the rental objects 110 for the rental owner interface 140 based on the availability of the rental objects 110 determined by the rental owner and the rental system 100. In some embodiments, the authorization process may be automatically performed by the rental system 100 as the service requests from the rental user based on the availability of the rental objects or based on the criteria preset by the rental owner, for example, the credential information of the rental user.

After the rental period of the rental user, the rental objects 110 are returned to the rental owner. The step of transmitting returning information of the rental objects 110 may include sending the returning information of the rental objects 110 from the rental user interface 130 to the rental owner interface 140. In some embodiments, as the rental user returning the rental objects, the rental owner interface 140 receives the returning information and sends alerts to the rental owner. The status of the returned rental objects will be updated for next rental service.

In some embodiments, after the specific rental objects 110 being returned, an alert may be also sent to other potential rental users who may have needs or are interested in renting the specific rental objects 110 in the near future. Specifically, the potential rental user may register to the rental system 100 for tracking the statuses of the interested rental objects for checking availabilities and scheduling the rental service.

What is claimed is:

1. A rental system, comprising:
a plurality of rental objects, docked in at least one rental location, and
at least one user device, comprising
a rental user interface, configured for making service requests of the plurality of rental objects and identifying one of the plurality of rental objects for rent;
a rental owner interface, configured for managing and authorizing the service requests of the plurality of rental objects;
a display, configured for displaying the rental user interface, the rental owner interface, and statuses the plurality of rental objects; and
a controlling circuit, configured to:
receive the service requests and returning notifications associated with the plurality of rental objects; and
authorize the service requests for renting the plurality of rental objects.

2. The rental system according to claim 1, wherein the controlling circuit is configured to detect a State of Charge (SOC) of battery units of the of the rental objects and to control the rental owner interface based on the detection of the battery states to display an option to transmit the service request to the rental user interface.

3. The rental system according to claim 1, wherein the controlling circuit is configured to detect defects or failures of the rental objects, wherein the controlling circuit control the rental owner interface based on the detection of the states of the rental objects to transmit an availability information of the rental objects to the rental user interface.

4. The rental system according to claim 1, wherein the at least one rental location comprises a garage, a storage, or a warehouse belonging to at least a rental owner of the plurality of rental objects.

5. The rental system according to claim 1, wherein the rental system further comprises a communication network configured for communicating between the rental user interface and the rental owner interface of the at least one user device.

6. The rental system according to claim 1, further comprising a server for receiving, storing, and transmitting data information from the rental user interface, the rental owner interface, or therebetween.

7. The rental system according to claim 1, wherein each of the plurality of rental objects has the identification labels for identifying associated information of the plurality of rental objects.

8. The rental system according to claim 7, wherein the identification labels comprise quick response (QR) code labels for identification by the at least a user device.

9. The rental system according to claim 7, wherein the identification labels comprise chip circuits for allowing Near-filed Communication (NFC) between the at least one user device and the plurality of rental objects.

10. The rental system according to claim 1, the least one user device comprises a plurality of user devices wireless communicated with each other.

11. A rental method for a plurality of rental objects docked in a rental location, comprising:
listing the plurality of rental objects docked in the rental location for rent by at least a rental owner through a rental owner interface of a rental system;
accessing to a rental user interface of the rental system by at least a rental user to make service requests for the plurality of rental objects;
determining availabilities of the plurality of rental objects requested by the service requests made from the at least a rental user;
authorizing the service requests through the rental owner interface for renting out the plurality of rental objects; and
transmitting returning information of the rental objects from the rental user interface to the rental owner interface for informing returns of the plurality of rental objects to the rental owners.

12. The rental method according to claim 11, wherein the rental user interface and the rental owner interface are implemented by an application software installed in user devices of the rental system.

13. The rental method according to claim 11, wherein the step of listing the rental objects comprises registering to the rental system by inputting information of the rental owner through the rental owner interface.

14. The rental method according to claim 13, wherein the information of the rental owner comprises the rental location and contact information of the rental owner.

15. The rental method according to claim 11, wherein the step of determining availabilities of the plurality of rental objects comprises detecting the operational status of the rental objects by a controlling circuit of the rental system.

16. The rental method according to claim 11, wherein the step of determining availabilities of the plurality of rental objects comprises detecting at least one of a current State of Charge (SOC) of a battery unit of the rental objects by a control unit of the rental system.

17. The rental method according to claim 11, wherein the step of transmitting returning information of the rental objects from the rental user interface to the rental owner interface comprising scanning identification labels on the rental objects to activate transmission of the returning information to the rental owner.
